(19) United States
(12) Patent Application Publication
(10) Pub. No.: US 2025/0096723 A1
(43) Pub. Date: Mar. 20, 2025

(54) FLOATING PHOTOVOLTAIC PLATFORM

(71) Applicants: Milian Borisov ARSOV, Sofia (BG); WATO POWER OOD, Sofia (BG)

(72) Inventor: Milian Borisov ARSOV, Sofia (BG)

(73) Assignees: Milian Borisov ARSOV, Sofia (BG); WATO POWER OOD, Sofia (BG)

(21) Appl. No.: 18/573,122

(22) PCT Filed: Oct. 2, 2023
(86) PCT No.: PCT/EP2023/025415

§ 371 Date: Dec. 21, 2023

(30) Foreign Application Priority Data
Oct. 12, 2022 (BG) BG/P/2022/113599
Sep. 19, 2023 (GB) GB2314330.8

(51) Int. Cl. H02S 20/30; B63B 1/12; B63B 35/44

(52) U.S. Cl. CPC H02S 20/30; B63B 1/121; B63B 35/44; B63B 2035/4453

(57) ABSTRACT

This invention concerns a floating photovoltaic (PV) platform for use in the field of solar energy. In particular invention concerns a floating PV platform for construction of floating photovoltaic installations. More in particular, the floating PV platform includes a supporting metal structure on the underside of a supporting element pontoon bodies forming groups, each group are fixed to a metal frame of the supporting metal structure and PV modules, where the angle of the PV modules can be adjusted automatically. The floating photovoltaic platform of the present invention includes a supporting metal structure on the underside of a supporting element (2) pontoon bodies (1) formed in groups (10) are established, each group (10) being fixed to a metal frame (14) of the supporting metal structure. On the upper side of the element (2) are PV modules (5), each of which is composed of a frame (7) in which photovoltaic panels are housed (6). The photovoltaic modules (5) are mobile with the possibility of varying their angle relative to the horizon from −15° to +45° by means of a lever module composed of an upper arm (9), a lower arm (4) and an actuator (8). The upper arm (9) and the lower arm (4) at one end are connected to the working body of the actuator (8) and the other end of the upper arm (9) is connected to one end of the frame (7) of the PV modules (5), the other end of the lower arm (4) being connected to a supporting beam (12) of the supporting metal structure. The opposite end of the frame (7) is connected to a bearing body (15) established to element (2). The movable PV modules (5) are arranged on element (2) in two oppositely located photovoltaic fields (13.a and 13.b) separated from each other by a service path (11), each photovoltaic field (13.a and 13.b) being composed of the photovoltaic modules (5) arranged in rows, whereby each row is composed of photovoltaic modules (5), the service path (11) being composed of elements, removably connected to each other and covered by a retroreflective coating (3).

### FIELD OF THE TECHNOLOGY

This invention concerns a floating photovoltaic (PV) platform for use in the field of capture of solar energy. In particular, the invention concerns a floating PV platform for construction of floating photovoltaic installations. More in particular, the floating PV platform includes a supporting metal structure on the underside of a supporting element pontoon bodies forming groups, each group are fixed to a metal frame of the supporting metal structure and PV modules, where the angle of the PV modules can be adjusted automatically.

### BACKGROUND OF THE INVENTION

Floating PV systems are an emerging market with the potential for rapid growth. The demand for floating photovoltaic systems is growing, especially in island and other land-restricted countries, as the cost of water surfaces is generally cheaper than that of land. Such floating solar systems are particularly suitable for Asia, where the land area is lacking, but there are many hydropower dams with ready transmission infrastructure. Across other continents such as for instance North and South America, Europe and Australia, there is also have a realistic potential and pressing demand for applications of floating PV systems. Particular territories with recognised interest include for instance Canada, USA, Mexico, Brazil, Great Britain, Netherlands and France. The engineering challenges to be overcome with these known systems are, for example, anchor equipment, which must be designed to withstand the dynamic forces of waves and strong winds, but specialists in the field do not yet have enough experience to apply such systems to floating plants, which is why these installations are always largely mobile and not fixed in a stable location. This relative mobility and inevitable of certainty present issues which must be addressed appropriately.

Providing additional space, floating photovoltaic systems are relatively easy to install and their efficiency is supported by additional water cooling provided by the water located underneath the systems. In addition, if necessary, they can change their place.

The PV systems themselves include photovoltaic modules, each of which is a system of photovoltaic panel modules mounted on a common panel and connected in series or in parallel, depending on the desired values of current and voltage at a set power.

WO2020/225382A1 is concerned with a floating carrier device which is intended for harnessing solar power and production of solar energy. The floating device includes a supporting metal structure composed of a main supporting element, on the underside of which a pontoon body is established at each of its two ends. Photovoltaic modules or platforms are located on the upper side of the load-bearing element, each of which is rigidly fixed to a shoulder fixed on the main load-bearing element. Photovoltaic modules or platforms, include a framework in which photovoltaic panels are housed. Thus, the photovoltaic modules are stationary and fixed at a certain degree on the fixed metal structure, the angle between the photovoltaic panels and the surface of the load-bearing element remaining always constant relative to the horizon, therefore the modules are in the same position without regard to the change in the meteorological situation.

Photovoltaic modules or platforms are mechanically fixed, in which the opposite panels are located in close proximity and form a common “edge”, with a distance between them within a few centimetres.

The lower edge of the photovoltaic module or platform, which is closest to the water surface, is a few centimetres above the pontoon bodies and above the supporting structure. In this constructed floating carrier under the photovoltaic modules there is no reflecting surface and relies solely on the natural reflection of light from the water surface, which is extremely weak and low intensity-as low as approximately 4-5% or even less.

There is a pressing need for a new or improved photovoltaic modules or platforms which address at least some of the above shortcomings of the existing solar energy harnessing systems.

### SUMMARY OF THE INVENTION

The present invention relates to a floating photovoltaic platform.

The present invention also relates to a floating photovoltaic platform with increased performance caused by more efficient utilization of solar energy and longer life due to elimination of the possibility of accidents caused by changing climatic conditions and anchorage issues.

In one aspect of the present invention, there is provided a floating photovoltaic platform comprising a supporting metal structure on the underside of a main supporting element pontoon bodies formed in groups are established, each group being fixed to a metal frame of the supporting metal structure, wherein on the upper side of the main supporting element are PV modules, each of which is composed of a frame in which photovoltaic panels are housed.

In some embodiments of the present invention, there is provided a floating photovoltaic platform comprising a supporting metal structure on the underside of a main supporting element (2) pontoon bodies (1) formed in groups (10) are established, each group (10) being fixed to a metal frame (14) of the supporting metal structure, wherein on the upper side of the main supporting element (2) are PV modules (5), each of which is composed of a frame (7) in which photovoltaic panels are housed (6).

In some embodiments of the present invention, there is provided a floating photovoltaic platform, wherein the supporting metal structure on the underside of a main load-bearing element pontoon bodies are established, with photovoltaic modules located on the upper side of the main load-bearing element, each of which is composed of a frame containing photovoltaic panels, where the pontoon bodies groups of pontoon bodies are formed, each group of pontoon bodies being fixed to a metal frame of the supporting metal structure, a lower arm and an actuator in which the upper arm and the lower arm at one end are connected to the working body of the actuator and the other end of the upper arm is connected to one end of the frame of the PV modules, the other end of the lower arm being connected by a supporting beam of the supporting metal structure, the opposite end of the frame being connected to a bearing body, established to the main carrier element, and shielding elements are established between the supporting beam and the main carrier element, whereby the movable photovoltaic modules are arranged on the main carrier element in two opposite photovoltaic fields separated from each other by a service path, each photovoltaic field being composed of the photovoltaic modules arranged in rows, the service path being composed of elements, removably connected to each other and covered by a retroreflective coating.

In some embodiments, the positioning of the mobile photovoltaic modules and their movement can be adjusted relative to the change of the sun as controlled by an electronic system, the electronic system including sensor devices to detect the intensity of the sun, the location of the sun and other environmental parameters.

In some embodiments of the present invention, there is provided a floating photovoltaic platform, wherein the supporting metal structure on the underside of a main load-bearing element pontoon bodies are established, with photovoltaic modules located on the upper side of the main load-bearing element, each of which is composed of a frame containing photovoltaic panels, where the pontoon bodies (1) groups (10) of pontoon bodies (1) were formed, each group (10) of pontoon bodies (1) being fixed to a metal frame (14) of the supporting metal structure, a lower arm (4) and an actuator (8) in which the upper arm (9) and the lower arm (4) at one end are connected to the working body of the actuator (8) and the other end of the upper arm (9) is connected to one end of the frame (7) of the PV modules (5), the other end of the lower arm (4) being connected by a supporting beam (12) of the supporting metal structure, the opposite end of the frame (7) being connected to a bearing body (15), established to the main carrier element (2), and shielding elements are established between the supporting beam (12) and the main carrier element (2), whereby the movable photovoltaic modules (5) are arranged on the main carrier element (2) in two opposite photovoltaic fields (13.a and 13.b) separated from each other by a service path (11), each photovoltaic field (13.a and 13.b) being composed of the photovoltaic modules (5) arranged in rows, the service path (11) being composed of elements, and covered by a retroreflective coating (3).

In some embodiments of the present invention, there is provided a floating photovoltaic platform, wherein the supporting metal structure on the underside of a main load-bearing element pontoon bodies are established, with photovoltaic modules located on the upper side of the main load-bearing element, each of which is composed of a frame containing photovoltaic panels, where the pontoon bodies (1) groups (10) of pontoon bodies (1) were formed, each group (10) of pontoon bodies (1) being fixed to a metal frame (14) of the supporting metal structure, a lower arm (4) and an actuator (8) in which the upper arm (9) and the lower arm (4) at one end are connected to the working body of the actuator (8) and the other end of the upper arm (9) is connected to one end of the frame (7) of the PV modules (5), the other end of the lower arm (4) being connected by a supporting beam (12) of the supporting metal structure, the opposite end of the frame (7) being connected to a bearing body (15), established to the main carrier element (2), and shielding elements are established between the supporting beam (12) and the main carrier element (2), whereby the movable photovoltaic modules (5) are arranged on the main carrier element (2) in two opposite photovoltaic fields (13.a and 13.b) separated from each other by a service path (11), each photovoltaic field (13.a and 13.b) being composed of the photovoltaic modules (5) arranged in rows, each row being composed of three to four photovoltaic modules (5), and the rows are from one to three, the service path (11) being composed of elements, removably connected to each other and covered by a retroreflective coating (3).

In some embodiments, the positioning of the mobile photovoltaic modules (5) and their movement can be adjusted relative to the change of the sun as controlled by an electronic system, the electronic system including sensor devices to detect the intensity of the sun, the location of the sun and other environmental parameters.

In some embodiments of the present invention, there is provided a floating photovoltaic platform, wherein the angle of the photovoltaic modules (5) can be adjusted relative to the horizon.

In some embodiments of the present invention, there is provided a floating photovoltaic platform, wherein the angle of the photovoltaic modules (5) can be adjusted relative to the horizon from between approximately −15° to approximately +45°. In some further embodiments of the present invention, there is provided a floating photovoltaic platform, wherein the angle of the photovoltaic modules (5) can be adjusted relative to the horizon from between −12.5° to +42.5°.

The present inventors surprisingly observed that the ability to modify the angle of the photovoltaic modules increases the life of the floating photovoltaic platform due to the possibility of bringing the photovoltaic modules substantially horizontally for instance in hazardous weather condition such as high winds. The present inventors also surprisingly observed that the ability to modify the angle of the photovoltaic modules to a substantially horizontal plane can reduce wind resistance leading to safer and more stable photovoltaic platforms. Advantageously, the ability to modify the angle of the photovoltaic modules to a substantially horizontal plane can reduce issues associated with anchor. Advantageously, the ability to modify the angle of the photovoltaic modules to a substantially horizontal plane can reduce issues associated with anchor while at the same time increase the harnessing of solar energy efficiency.

In some embodiments of the present invention, there is provided a floating photovoltaic platform, wherein the photovoltaic panels (6) arranged in each PV module (5) are located with their long side parallel to the horizon.

In some embodiments of the present invention, there is provided a floating photovoltaic platform, wherein the distance between the nearest edges of the frames (7) of the mobile photovoltaic modules (5) is in the range of between approximately 0.1 to 3 m. In some further embodiments of the present invention, there is provided a floating photovoltaic platform, wherein the distance between the nearest edges of the frames (7) of the mobile photovoltaic modules (5) is in the range of between approximately 0.5 to 2.5 m.

In some embodiments of the present invention, there is provided a floating photovoltaic platform, wherein the bottom surface of the photovoltaic panels (6) further comprises reflective elements.

In some embodiments of the present invention, there is provided a floating photovoltaic platform, wherein the actuator (8) is a linear actuator.

In some embodiments of the present invention, there is provided a floating photovoltaic platform, wherein the reflective coating (3) is a reflective paint.

In some embodiments of the present invention, there is provided a floating photovoltaic platform, wherein the shielding elements are made of PVC or high-density polyethylene, or textiles, or fiberglass, or other material with increased reflectivity.

In one aspect of the present invention there is provided a method of constructing a floating photovoltaic platform, the method comprising the steps of
a. providing a supporting metal structure on the underside of a main supporting element pontoon bodies formed in groups are established, each group being fixed to a metal frame of the supporting metal structure, wherein on the upper side of the main supporting element are PV modules, each of which is composed of a frame in which photovoltaic panels are housed;
b. placing the photovoltaic platform on a floating surface;
c. obtaining a floating photovoltaic platform.

In some embodiments of the present invention, there is provided method of constructing a floating photovoltaic platform, the method comprising the steps of
a. providing a supporting metal structure on the underside of a main supporting element (2) pontoon bodies (1) formed in groups (10) are established, each group (10) being fixed to a metal frame (14) of the supporting metal structure, wherein on the upper side of the main supporting element (2) are PV modules (5), each of which is composed of a frame (7) in which photovoltaic panels are housed (6);
b. placing the photovoltaic platform on a floating surface; and
c. obtaining a floating photovoltaic platform.

In some embodiments of the present invention, the method comprises supplying a supporting metal structure on the underside of a main load-bearing element pontoon bodies are established, with photovoltaic modules located on the upper side of the main load-bearing element, each of which is composed of a frame containing photovoltaic panels, where the pontoon bodies (1) groups (10) of pontoon bodies (1) were formed, each group (10) of pontoon bodies (1) being fixed to a metal frame (14) of the supporting metal structure, whereby the photovoltaic modules (5) were movable with the possibility of changing their angle relative to the horizon from −15° to +45° by a lever module composed of an upper arm (9), a lower arm (4) and an actuator (8) in which the upper arm (9) and the lower arm (4) at one end are connected to the working body of the actuator (8) and the other end of the upper arm (9) is connected to one end of the frame (7) of the PV modules (5), the other end of the lower arm (4) being connected by a supporting beam (12) of the supporting metal structure, the opposite end of the frame (7) being connected to a bearing body (15), established to the main carrier element (2), and shielding elements are established between the supporting beam (12) and the main carrier element (2), whereby the movable photovoltaic modules (5) are arranged on the main carrier element (2) in two opposite photovoltaic fields (13.a and 13.b) separated from each other by a service path (11), each photovoltaic field (13.a and 13.b) being composed of the photovoltaic modules (5) arranged in rows, the service path 11 being composed of elements, removably connected to each other and covered by a retroreflective coating (3).

In some embodiments of the method of the present invention, each row is composed of three to four photovoltaic modules (5), and wherein the rows are from one to three.

In some embodiments of the method of the present invention, the positioning of the mobile photovoltaic modules and their movement is adjusted relative to the change of the sun as controlled by an electronic system, the electronic system including sensor devices to detect the intensity of the sun, the location of the sun and other environmental parameters.

These and other features, aspects and advantages of the present invention will become better understood with reference to the following drawings, description, and claims.

### BRIEF DESCRIPTION OF THE DRAWINGS

The present invention is illustrated in the attached figures where:

FIG. 1 is a top view of a set of an unlimited number of floating photovoltaic platforms, arranged in rows and columns, connected to each other and forming a photovoltaic electricity production park;

FIG. 2 represents a magnified image A showing a placement of elements of FIG. 1;

FIG. 3 is an axonometric image of the main supporting metal structure of a floating photovoltaic platform with the arrangement of groups of pontoon bodies;

FIG. 4 is an axonometric image of a pair of symmetrically arranged closed movable frames of PV modules from a floating PV platform;

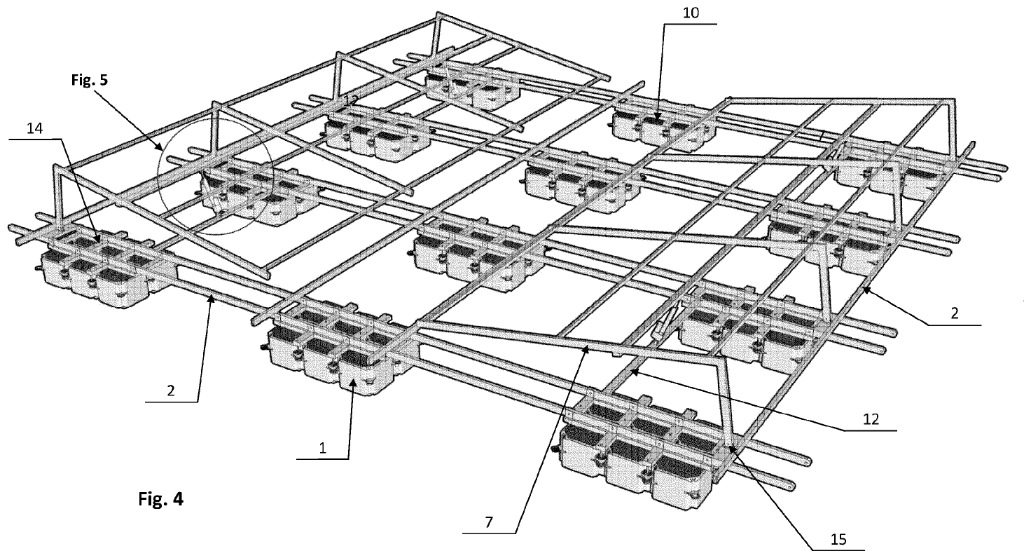

FIG. 5 represents a magnified image B, showing a placement of elements of FIG. 4;

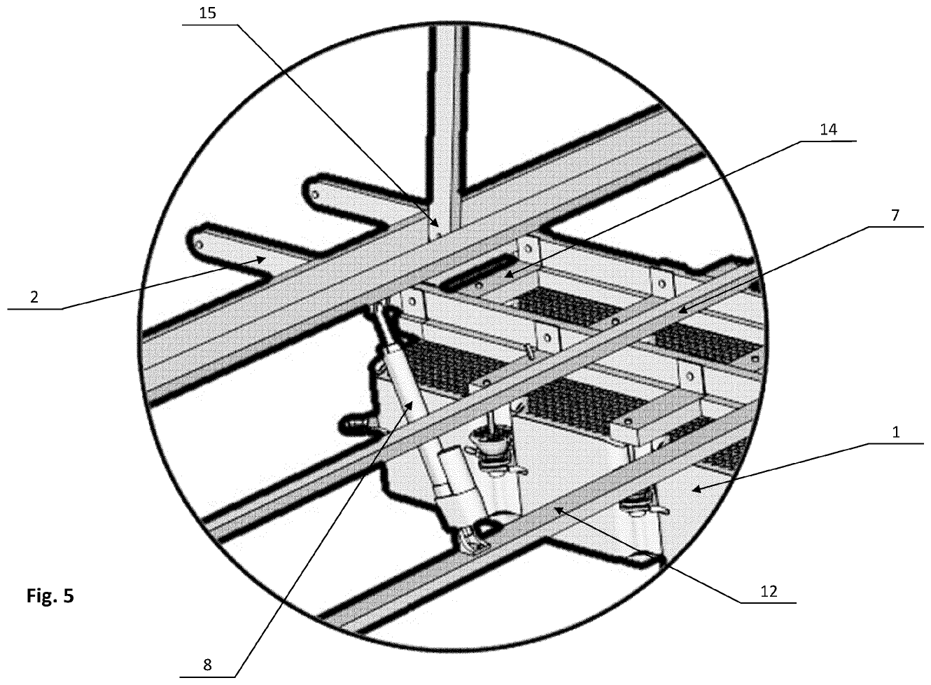

FIG. 6 represents an axonometric image of both a pair of symmetrically arranged and open at 5° to the horizon moving frames from the PV modules from a floating PV platform and of service paths located in horizontal position and those at an angle;

FIG. 7 represents a look at the side of a pair of symmetrically located closed at −15° to the horizon photovoltaic modules from a floating PV platform;

FIG. 8 represents a view from the side of a pair of symmetrically located open at 45° to the horizon movable frames with photovoltaic panels of floating photovoltaic platform and service walkways located on them; and

FIG. 9 is a view from the side of a pair of movable frames with photovoltaic panels from a floating PV platform, one photovoltaic field being translated into the −15° position and the other photovoltaic field being raised 45° to the horizon, by means of a lever module driven by a linear actuator (8).

### DETAILED DESCRIPTION OF THE INVENTION

Throughout this disclosure, various scientific publications, patents and published patent specifications are referenced by an identifying citation. The disclosures of these publications, patents and published patent specifications are hereby incorporated by reference into the present disclosure to more fully describe the state of the art to which this disclosure pertains.

As used herein, certain terms may have the following defined meanings.

As used in the specification and the claims, the singular form “a,” “an” and “the” include singular and plural references unless the context clearly dictates otherwise. For example, the term “module”, “supporting element” or “pontoon bodies” includes a single or plurality of modules, supporting element or pontoon bodies.

Throughout the specification, when an element or module is said to be located “on” another member or module, this includes not only a case in which the member or module is in contact with another member or module but also a case in which there is another member or modules between the two members or modules.

Throughout the specification, when for example an element or module is “connected” or “coupled” to another element or module, this includes not only a case of being “directly connected or coupled” but also a case of being “removably connected” with another for example element or module interposed therebetween.

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a floating photovoltaic platform. The terms “floating photovoltaic platform” and “floating photovoltaic system” are used interchangeably and have the same meaning within the context of the present invention.

The floating photovoltaic platform of the present invention comprises a supporting metal structure on the underside of a main supporting element pontoon bodies formed in groups are established, each group being fixed to a metal frame of the supporting metal structure, wherein on the upper side of the main supporting element are PV modules, each of which is composed of a frame in which photovoltaic panels are housed.

An embodiment of the present invention provides a floating photovoltaic platform comprising a supporting metal structure on the underside of a main supporting element (2) pontoon bodies (1) formed in groups (10) are established, each group (10) being fixed to a metal frame (14) of the supporting metal structure, wherein on the upper side of the main supporting element (2) are PV modules (5), each of which is composed of a frame (7) in which photovoltaic panels are housed (6).

In some embodiments of the present invention, there is provided a floating photovoltaic platform, wherein the supporting metal structure on the underside of a main load-bearing element pontoon bodies are established, with photovoltaic modules located on the upper side of the main load-bearing element, each of which is composed of a frame containing photovoltaic panels, where the pontoon bodies (1) groups (10) of pontoon bodies (1) were formed, each group (10) of pontoon bodies (1) being fixed to a metal frame (14) of the supporting metal structure, a lower arm (4) and an actuator (8) in which the upper arm (9) and the lower arm (4) at one end are connected to the working body of the actuator (8) and the other end of the upper arm (9) is connected to one end of the frame (7) of the PV modules (5), the other end of the lower arm (4) being connected by a supporting beam (12) of the supporting metal structure, the opposite end of the frame (7) being connected to a bearing body (15), established to the main carrier element (2), and shielding elements are established between the supporting beam (12) and the main carrier element (2), whereby the movable photovoltaic modules (5) are arranged on the main carrier element (2) in two opposite photovoltaic fields (13.a and 13.b) separated from each other by a service path (11), each photovoltaic field (13.a and 13.b) being composed of the photovoltaic modules (5) arranged in rows, each row being composed of three to four photovoltaic modules (5), and the rows are from one to three, the service path (11) being composed of elements, removably connected to each other and covered by a retroreflective coating (3).

In some embodiments, the positioning of the mobile photovoltaic modules (5) and their movement can be adjusted relative to the change of the sun as controlled by an electronic system, the electronic system including sensor devices to detect the intensity of the sun, the location of the sun and other environmental parameters.

It would readily be appreciated by those of skill in the art that angle of the photovoltaic modules can be adjusted relative to the horizon which is suitable for optimal collection of solar radiation or solar energy. It would also readily be appreciated by those of skill in the art that angle of the photovoltaic modules can be adjusted relative to the horizon which is suitable for optimal collection of incidental solar radiation or incidental solar energy. It would also readily be appreciated by those of skill in the art that angle of the photovoltaic modules can be adjusted relative to the horizon which is suitable for optimal collection of reflected solar radiation or reflected solar energy. The present inventors also surprisingly observed that the ability to modify the angle of the photovoltaic modules increases the life of the floating photovoltaic platform due to the possibility to bring the photovoltaic modules substantially horizontally for instance in hazardous weather condition such as high winds. The present inventors also surprisingly observed that the ability to modify the angle of the photovoltaic modules to a substantially horizontal plane can reduce wind resistance leading to safer and more stable photovoltaic platforms. Advantageously, the ability to modify the angle of the photovoltaic modules to a horizontal plane can reduce issues associated with anchorage of the platforms.

The present inventors observed that the optimal angle of the photovoltaic modules can be adjusted relative to the horizon and that that angel could be from between approximately −15° to approximately +45°. In some embodiments of the present invention, there is provided a floating photovoltaic platform, wherein the angle of the photovoltaic modules (5) can be adjusted relative to the horizon from between approximately −15° to approximately +45°. In some further embodiments of the present invention, there is provided a floating photovoltaic platform, wherein the angle of the photovoltaic modules (5) can be adjusted relative to the horizon from between −12.5° to +42.5°. In some further embodiments of the present invention, there is provided a floating photovoltaic platform, wherein the angle of the photovoltaic modules (5) can be adjusted relative to the horizon from between −10° to +40°. In some further embodiments of the present invention, there is provided a floating photovoltaic platform, wherein the angle of the photovoltaic modules (5) can be adjusted relative to the horizon from between −7.5° to +35°. In some further embodiments of the present invention, there is provided a floating photovoltaic platform, wherein the angle of the photovoltaic modules (5) can be adjusted relative to the horizon from between −5° to +30°. In some further embodiments of the present invention, there is provided a floating photovoltaic platform, wherein the angle of the photovoltaic modules (5) can be adjusted relative to the horizon from between −1° to +25°. In some further embodiments of the present invention, there is provided a floating photovoltaic platform, wherein the angle of the photovoltaic modules (5) can be adjusted relative to the horizon from between +2.5° to +20°. In some further embodiments of the present invention, there is provided a floating photovoltaic platform, wherein the angle of the photovoltaic modules (5) can be adjusted relative to the horizon from between +5° to +15°. In some further embodiments of the present invention, there is provided a floating photovoltaic platform, wherein the angle of the photovoltaic modules (5) can be adjusted relative to the horizon at 10°.

The present inventors observed that the photovoltaic panels arranged in each PV module can be arranged or located with their long side substantially parallel to the horizon. In some embodiments of the present invention, there is provided a floating photovoltaic platform, wherein the photovoltaic panels (6) arranged in each PV module (5) are located with their long side substantially parallel to the horizon.

In some embodiments of the present invention, there is provided a floating photovoltaic platform, wherein the distance between the nearest edges of the frames (7) of the mobile photovoltaic modules (5) is in the range of between approximately 0.1 to 3 m. In some further embodiments of the present invention, there is provided a floating photovoltaic platform, wherein the distance between the nearest edges of the frames (7) of the mobile photovoltaic modules (5) is in the range of between approximately 0.3 to 2.7 m. In some further embodiments of the present invention, there is provided a floating photovoltaic platform, wherein the distance between the nearest edges of the frames (7) of the mobile photovoltaic modules (5) is in the range of between approximately 0.5 to 2.5 m. In some further embodiments of the present invention, there is provided a floating photovoltaic platform, wherein the distance between the nearest edges of the frames (7) of the mobile photovoltaic modules (5) is in the range of between approximately 0.75 to 2 m. In some further embodiments of the present invention, there is provided a floating photovoltaic platform, wherein the distance between the nearest edges of the frames (7) of the mobile photovoltaic modules (5) is in the range of between approximately 1 to 1.75 m. In some further embodiments of the present invention, there is provided a floating photovoltaic platform, wherein the distance between the nearest edges of the frames (7) of the mobile photovoltaic modules (5) is in the range of between approximately 1.25 to 1.5 m.

In some embodiments of the present invention, there is provided a floating photovoltaic platform, wherein the bottom surface of the photovoltaic panels (6) further comprises reflective elements.

As used herein, the term “alteration” may be used interchangeably with the terms, “alter” or “modify”, “modulate” such as “increase” in the utilisation or efficiency of harnessing for example direct or reflected solar radiation or solar energy by the photovoltaic platform or system of the present invention. In some embodiments of the present invention, the term “alteration” may be used interchangeably with the terms, “alter” or “modify”, “modulate” such as “increase” in the efficiency of power generation by harnessing for example direct or reflected solar radiation or solar energy by the photovoltaic platform or system of the present invention.

The terms “solar” and “sunlight” are used interchangeably in the context of the present invention.

In some embodiments, the increased utilisation or efficiency is at least 0.001%, 0.005%, 0.01%, 0.05%, 0.08%, 0.1%, 0.15%, 0.2%, 0.4%, 0.5%, 0.75%, 1%, 2%, 2.5%, 5%, 10%, 15%, 20%, 25%, 30%, 35%, 40%, 45%, 50%, 55%, 60%, 65%, 70%, 75%, 80%, 85%, 90%, 95% or 100% or greater compared to control or base level.

In some embodiments of the present invention, the increased utilisation or efficiency is at least 0.5%.

In some embodiments of the present invention, the increased in efficiency of power generation is at least 0.5%.

In some embodiments of the present invention, the increased in efficiency of power generation is at least 0.75%.

In some embodiments of the present invention, the increased in efficiency of power generation is at least 1%.

In some embodiments of the present invention, the increased in efficiency of power generation is at least 2%.

In some embodiments of the present invention, the increased in efficiency of power generation is at least 2.5%.

In some embodiments of the present invention, the increased in efficiency of power generation is at least 5%.

In some embodiments of the present invention, the increased in efficiency of power generation is at least 10%.

In some embodiments of the present invention, the increased in efficiency of power generation is at least 15%.

In some embodiments of the present invention, the increased in efficiency of power generation is at least 20% or more.

In some embodiments, increased utilisation or efficiency is at least 0.1, 0.25, 0.5, 1, 1.5, 2, 2.5, 3, 3.5, 4, 4.5, 5, 5.5, 6, 6.5, 7, 7.5, 8, 8.5, 9, 9.5, or 10-fold or greater compared to control or base level.

As used herein, the term “adjust relative to the horizon” means altering the angle of the photovoltaic modules with reference to a constant line such as the line of the horizon which is observed at the installation site of the floating photovoltaic platform or system of the present invention.

As used herein the term “substantially horizontal” or “substantially parallel to the horizon” means +/− variation tolerance around 180° of the angle of the photovoltaic modules with reference to the horizon for example to minimise negative impact on the floating photovoltaic platform of the present invention from adverse weather conditions. Adverse weather conditions include waves, high winds, tides and others. Actuators would be familiar to the skilled person. Example actuators include linear actuators. Without wishing to be bound by theory, linear actuators are mechanical devices generally used to move items through a multi-modular system in a linear fashion. Linear actuators may include different types and designs such as for example screw type, belt type or rod types and others. The linear actuator uses energy to develop force and motion in a linear manner, as opposed to a rotational motion seen in an electric motor. Linear actuators offer advantages including a simple design with minimal moving parts. They are self-contained and can achieve speeds which can readily be modulated. The linear actuator further benefits from having an identical behaviour extending and retracting which is yet a further preferred featured within the context of the present invention. The linear actuator can achieve a low force of actuation and can be highly durable under harsh environmental conditions such as water environment. In some embodiments of the present invention, there is provided a floating photovoltaic platform, wherein the actuator (8) is a linear actuator. In some embodiments the linear actuator is a screw type linear actuator. In some embodiments the linear actuator is a rod type actuator.

The skilled person in the art would appreciate that reflective coating is capable of reflecting radiation such as incident radiation or energy for example solar radiation or solar energy and what is not reflected is absorbed or transmitted. The skilled person in the art would be familiar with different reflective coatings which are preferably heat resistant and water resistant.

In some embodiments of the present invention, there is provided a floating photovoltaic platform, wherein the reflective coating is water resistant. In some embodiments of the present invention, there is provided a floating photovoltaic platform, wherein the reflective coating is marine water resistant. In some embodiments of the present invention, there is provided a floating photovoltaic platform, wherein the reflective coating is fresh water resistant.

In some embodiments of the present invention, there is provided a floating photovoltaic platform, wherein the reflective coating (3) is a reflective paint. In some embodiments of the present invention, there is provided a floating photovoltaic platform, wherein the reflective paint is water resistant. In some embodiments of the present invention, there is provided a floating photovoltaic platform, wherein the reflective paint is marine water resistant. In some embodiments of the present invention, there is provided a floating photovoltaic platform, wherein the reflective paint is fresh water resistant.

In some embodiments of the present invention, there is provided a floating photovoltaic platform, wherein the shielding elements are made of PVC or high-density polyethylene, or textiles, or fiberglass, or other material with increased reflectivity.

In one aspect of the present invention there is provided a method of constructing a floating photovoltaic platform, the method comprising the steps of:
a. providing a supporting metal structure on the underside of a main supporting element pontoon bodies formed in groups are established, each group being fixed to a metal frame of the supporting metal structure, wherein on the upper side of the main supporting element are PV modules, each of which is composed of a frame in which photovoltaic panels are housed;
d. placing the photovoltaic platform on a floating surface; and
e. obtaining a floating photovoltaic platform.

In some embodiments of the present invention, there is provided method of constructing a floating photovoltaic platform, the method comprising the steps of:
a. providing a supporting metal structure on the underside of a main supporting element (2) pontoon bodies (1) formed in groups (10) are established, each group (10) being fixed to a metal frame (14) of the supporting metal structure, wherein on the upper side of the main supporting element (2) are PV modules (5), each of which is composed of a frame (7) in which photovoltaic panels are housed (6);
d. placing the photovoltaic platform on a floating surface; and
e. obtaining a floating photovoltaic platform.

In some embodiments of the present invention, the method comprises supplying a supporting metal structure on the underside of a main load-bearing element pontoon bodies are established, with photovoltaic modules located on the upper side of the main load-bearing element, each of which is composed of a frame containing photovoltaic panels, where the pontoon bodies (1) groups (10) of pontoon bodies (1) were formed, each group (10) of pontoon bodies (1) being fixed to a metal frame (14) of the supporting metal structure, whereby the photovoltaic modules (5) were movable with the possibility of changing their angle relative to the horizon from −15° to +45° by a lever module composed of an upper arm (9), a lower arm (4) and an actuator (8) in which the upper arm (9) and the lower arm (4) at one end are connected to the working body of the actuator (8) and the other end of the upper arm (9) is connected to one end of the frame (7) of the PV modules (5), the other end of the lower arm (4) being connected by a supporting beam (12) of the supporting metal structure, the opposite end of the frame (7) being connected to a bearing body (15), established to the main carrier element (2), and shielding elements are established between the supporting beam (12) and the main carrier element (2), whereby the movable photovoltaic modules (5) are arranged on the main carrier element (2) in two opposite photovoltaic fields (13.a and 13.b) separated from each other by a service path (11), each photovoltaic field (13.a and 13.b) being composed of the photovoltaic modules (5) arranged in rows, the service path 11 being composed of elements, removably connected to each other and covered by a retroreflective coating (3).

In some embodiments of the method of the present invention, each row is composed of three to four photovoltaic modules (5), and wherein the rows are from one to three.

In some embodiments of the method of the present invention, the positioning of the mobile photovoltaic modules and their movement can be adjusted relative to the change of the location of the sun as controlled by an electronic system. In some embodiment of the present invention, the electronic system includes sensor devices. In some embodiments of the present invention, sensor devices can detect the intensity of the sun, duration of sunshine, the location of the sun and optionally other environmental parameters. Suitable sensor devices would be familiar to the skilled person in the art.

As used in this application, the term “about” or “approximately” refers to a range of values within plus or minus 10% of the specified number. By way of non-limiting example, the term “about ten (10)” would encompass nine (9) to eleven (11) or 9-11. The term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than +45.0° degrees. For purposes of this disclosure, the term “transverse” means perpendicular, substantially perpendicular, or forming an angle between 55.0 and 125.0°. Also, for purposes of this disclosure, the term “length” means the longest dimension of an object. Also, for purposes of this disclosure, the term “width” means the dimension of an object such as an element or module, from side to side. For the purposes of this disclosure, the term “above” generally means superjacent, substantially superjacent, or higher than another object although not directly overlying the object.

Further, for purposes of this disclosure, the term “retroreflective coating” generally refers to a coating which is capable of reflecting radiation or energy such as solar radiation or solar energy backwards e.g. towards the bottom surface of the photovoltaic panels or elements. The present inventors surprisingly observed that reflecting solar radiation or solar energy backwards and thus towards the bottom surface of the photovoltaic panels increased the efficiency of the photovoltaic system of the present invention.

The use of any and all examples, or exemplary language (“e.g.,” “such as,” or the like) provided herein, is intended merely to better illuminate the embodiments and does not pose a limitation on the scope of the embodiments or the claims.

No language in the specification should be construed as indicating any unclaimed element as essential to the practice of the disclosed embodiments.

In the following description, it is understood that terms such as “first,” “second,” “top,” “bottom,” “up,” “down”, “upper”, “lower”, “above”, “below”, “beneath”, “front”, “back”, “over”, “under”, “left”, “right”, “end”, “upper arm”, “lower arm”, “edge” etc. are used with reference to the orientation of some of the components of the photovoltaic platform or photovoltaic system of the present invention. Since constituents or components in various embodiments described here can be positioned in a number of different orientations, locations of the floating surface, directional terminology is used for purposes of illustration only and is in no way limiting. The directional terminology is intended to be construed broadly, and therefore should not be interpreted to preclude components being oriented in different ways.

The disclosure illustratively described herein can suitably be practiced in the absence of any element or elements, limitation or limitations, not specifically disclosed herein. Thus, for example, the terms “comprising”, “including,” containing”, etc. shall be read expansively and without limitation.

As used herein the term “environmental parameters” includes for example temperature of the air, temperature of the water, air humidity, air quality and the like, which can be detected and characterised by the sensors and the data is generated which can be used to electronically such as automatically for instance remotely, enable the positioning or altering of the angle of the mobile photovoltaic modules and their movement.

### EMBODIMENTS OF THE PRESENT INVENTION

The present inventors surprisingly observed that they were able to address some of the problems in the art by creating a floating photovoltaic platform, which includes a supporting metal structure on the underside of a main supporting element are pontoon bodies, where the floating photovoltaic platform is able to harness not only radiation and energy from sunlight but also reflected back from the surface of the water rays which also carry beneficial radiation and energy.

On the upper side of the main load-bearing element are photovoltaic modules, each of which is composed of a frame in which photovoltaic panels are housed. According to embodiments of the invention, groups of pontoon bodies were formed, each group of pontoon bodies being fixed to a metal frame by the supporting metal structure. The photovoltaic modules are movable with the possibility of changing their angle to the horizon from −15° to +45° through a lever module.

The lever module can be composed of an upper arm, a lower arm and a linear actuator. The upper arm and the lower arm at one end are connected to the working body of the linear actuator. The other end of the upper arm is connected to one end of the frame of the PV modules and the other end of the lower arm is connected to a supporting beam from the supporting metal structure. The opposite end of the frame is connected to a bearing body established to the main load-bearing element.

The exact positioning of the mobile photovoltaic modules and their movement relative to the change of the solstice is controlled by a system including sensor devices to measure the intensity of the sun, its location, environmental indicators and the like. Shielding elements may be established between the supporting beam and the main load-bearing element.

The movable photovoltaic modules are arranged on the main carrier element in two oppositely located photovoltaic fields, separated from each other by a service path. Each photovoltaic field is composed of the photovoltaic modules arranged in rows, whereby each row is composed of three to four photovoltaic modules and the rows are one to three. The service path is composed of two elements, removably connected to each other and covered with a reflective coating. In the preferred implementation of the invention, the photovoltaic panels arranged in each PV module are located with their long side parallel to the horizon. The distance between the nearest edges of the frames of the movable photovoltaic modules is determined for each specific case and is in the range from between 0.5 to 3 meters (m).

It is possible to implement the invention, in which reflective elements are located under the lower surface of the photovoltaic panels. The retroreflective coating of the service path is a reflective paint, and the shielding elements can be made from durable materials such as PVC or high-density polyethylene, textile or fiberglass or other material with increased reflectivity. An advantage of the created floating photovoltaic platform is its increased performance due to the efficient utilization of solar energy due to the provided opportunity for optimal orientation of photovoltaic modules to the sun by applying a tracker system that ensures their control.

The presence of a reflective coating focuses the reflected light to the underside of the PV modules, which also leads to an increase in performance and efficiency overall on the platform. On the other hand, the presence of a service path located in the central part of the platform leads to an increase in airflow between the modules, and thus lowers their operating temperature. Servicing the platform is relatively inexpensive, providing it with a longer life due to the possibility of bringing photovoltaic modules substantially horizontal in high winds. This reduces wind resistance, and this is a prerequisite for fewer issues associated with accidents and anchors.

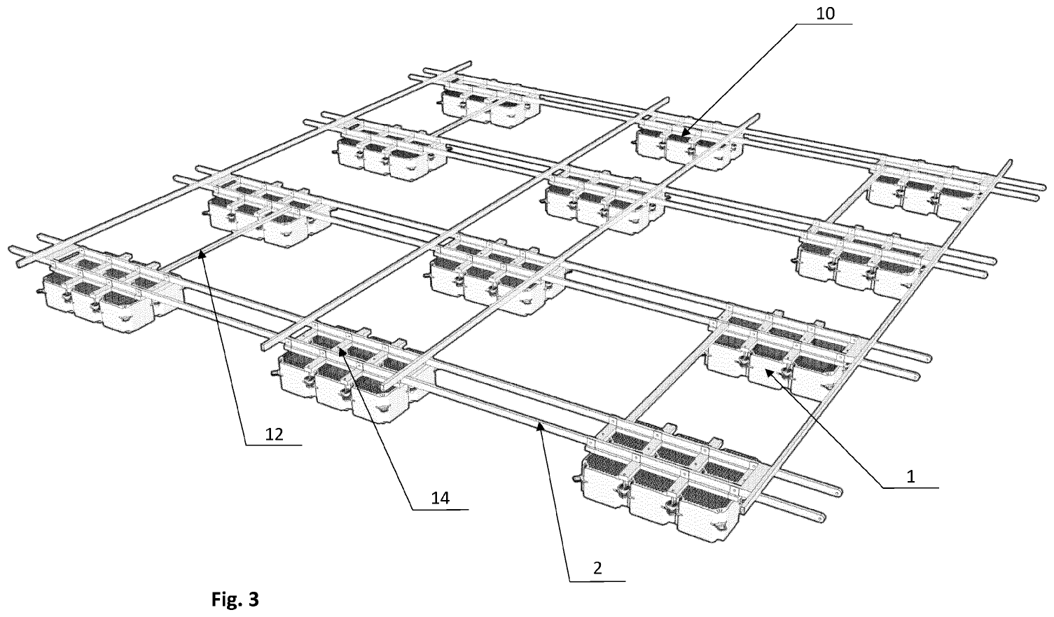

The created floating photovoltaic platform, shown in the attached figures, includes a supporting metal structure on the underside of a main supporting element 2 pontoon bodies 1 are established. Pontoon bodies 1 are formed in groups 10 of pontoon bodies 1, each group 10 of pontoon bodies 1 being fixed to metal frame 14 of the supporting metal structure shown in FIG. 3. On the upper side of the main load-bearing element 2 are movable photovoltaic modules 5, each of which is composed of frame 7, in which are housed photovoltaic panels 6.

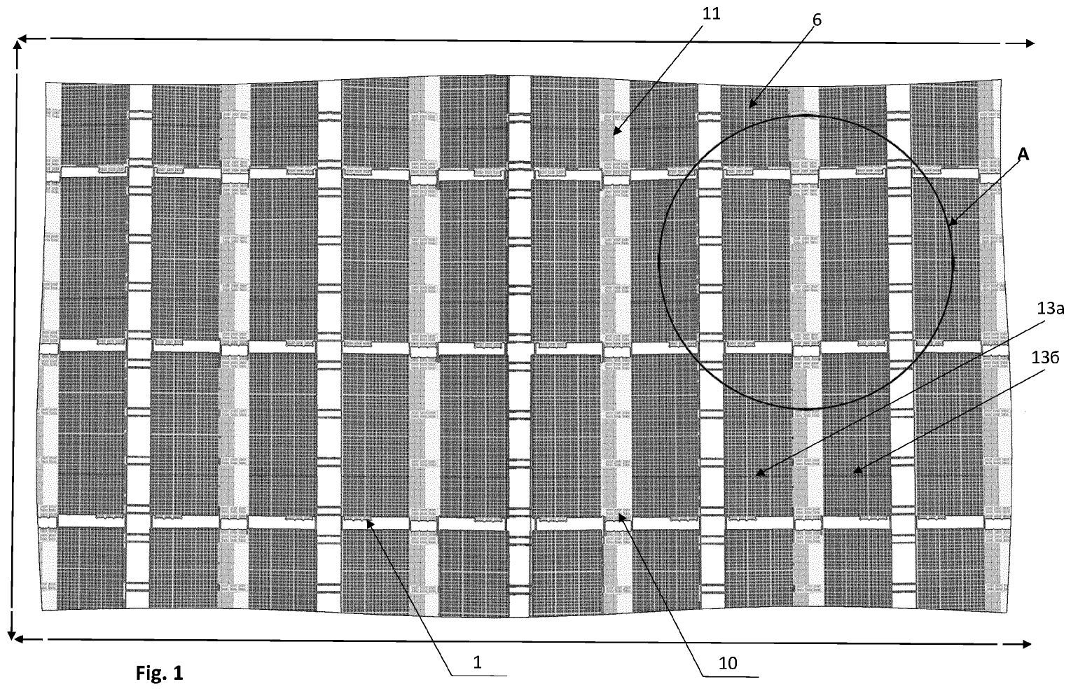

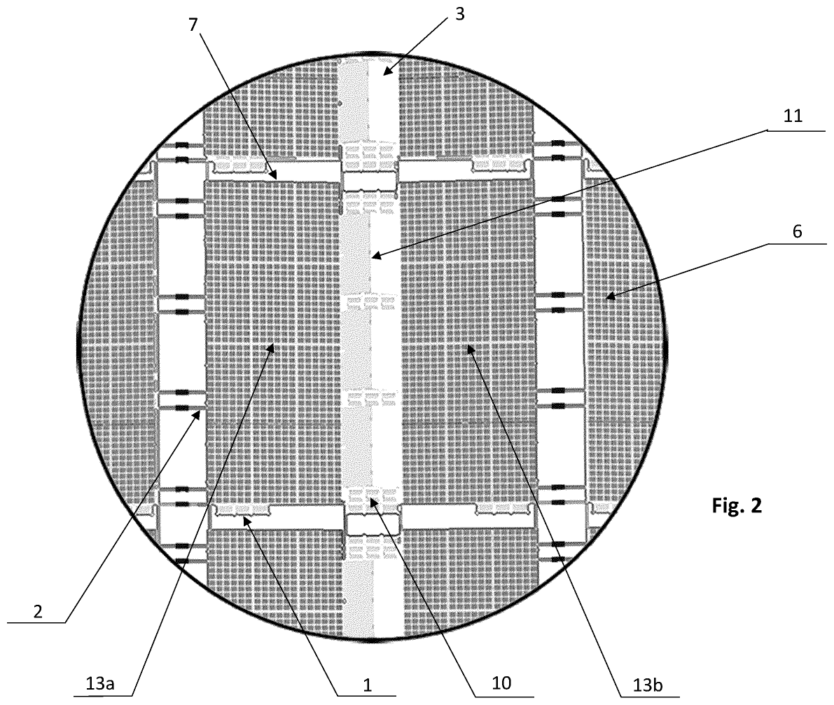

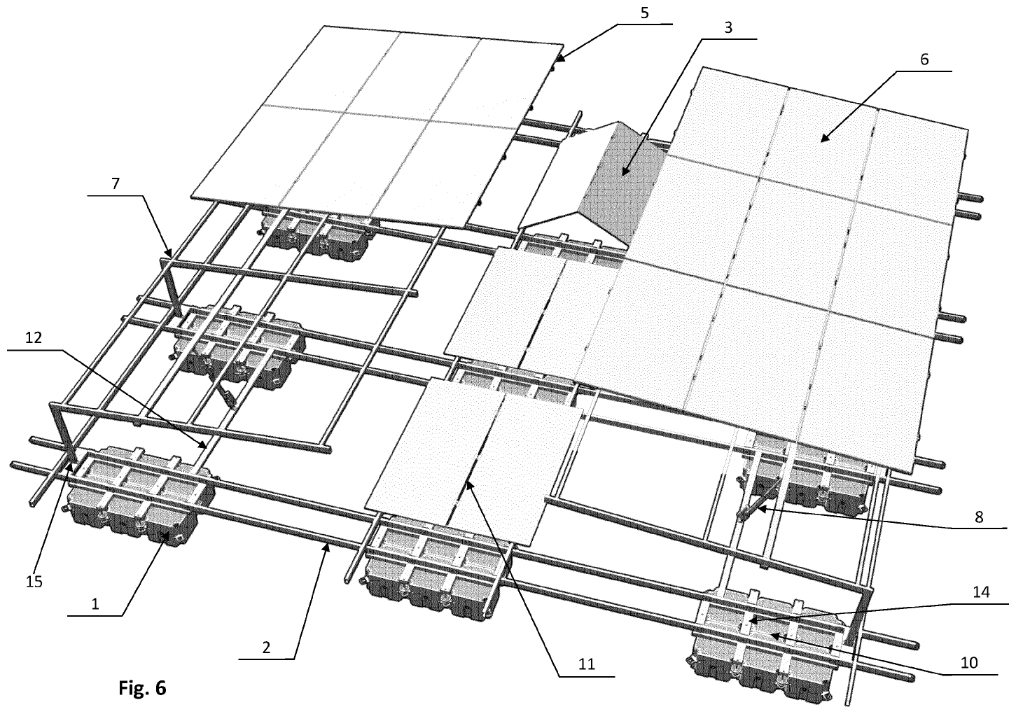

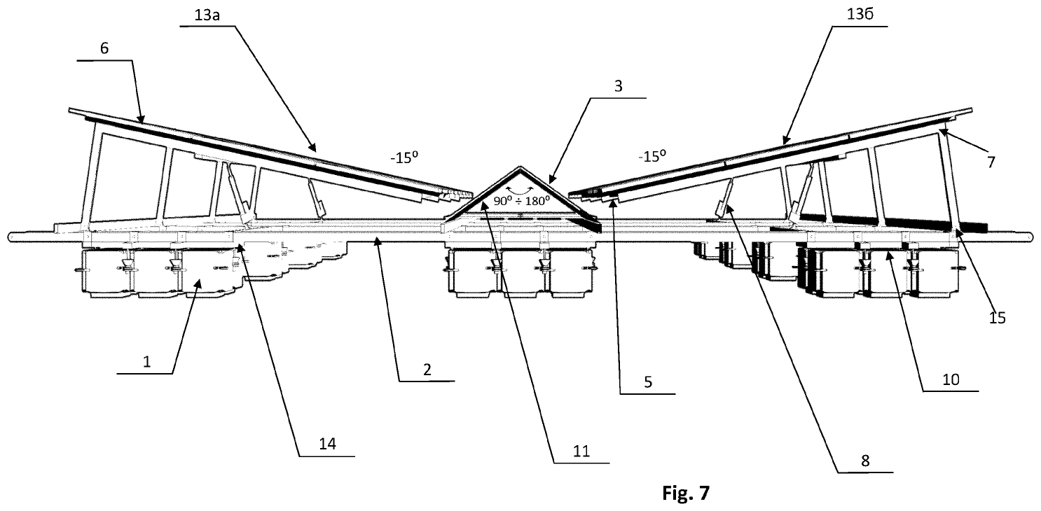

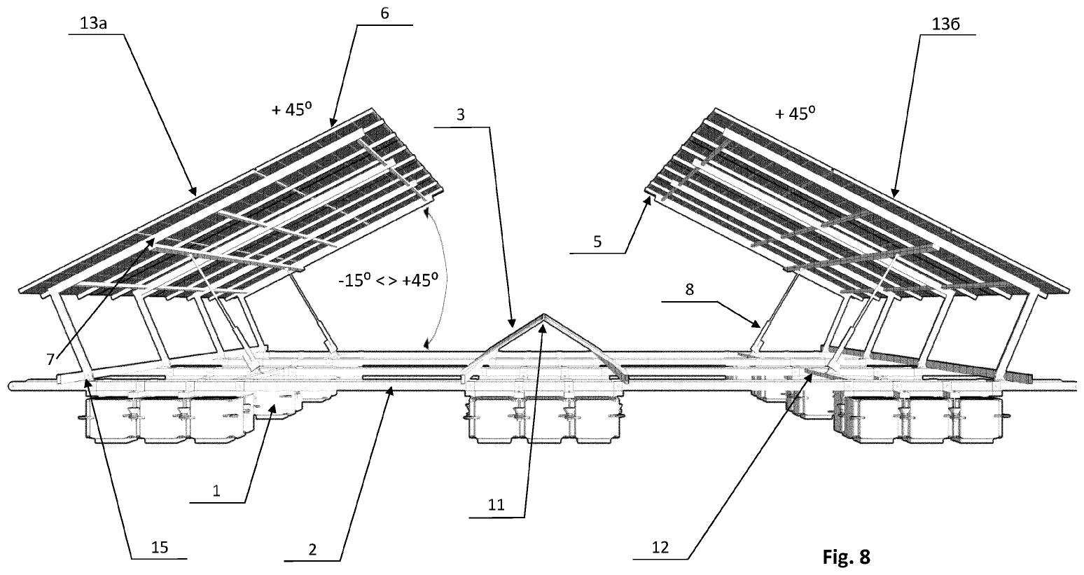

The photovoltaic panels 6 arranged in each PV module 5 are located with their long side parallel to the horizon shown in FIGS. 1 and 2. The distance between the nearest edges of the frames 7 of the mobile photovoltaic modules 5 is determined for each specific case and is in the range of 0.5 to 3 m. This allows the passage of a larger volume of air mass, as a result of which the cooling of the photovoltaic panels is improved 6. Cooling them with every degree lower operating temperature of the panel 6 results in a 0.5% higher efficiency of power generation. In addition, the distance between the frames 7 allows more direct and diffuse light to be felt, which increases the energy absorbed by the photovoltaic panels 6. It is possible to implement reflective elements under the lower surface of photovoltaic panels 6, i.e. 6 panels have two working surfaces, as a result of which the electricity performance of the platform increases. The created movable photovoltaic modules 5, shown in FIGS. 6 to 9, have the possibility of changing their angle to the horizon from −15° to +45° through a lever module.

The lever module, as evidenced by the figures referred to, is composed of an upper arm 9, a lower arm 4 and a linear actuator 8, which in the preferred performance under consideration is a linear actuator comprising a working body driven by an electric motor which is intended to realize an axial movement of the working organ.

The upper arm 9 and the lower arm 4 at one end are connected to the working body of the linear actuator 8. The other end of the upper arm 9 is connected to one end of frame 7 of PV modules 5, the other end of the lower arm 4 being connected to support beam 12 of the supporting metal structure. The opposite end of frame 7 is connected to bearing body 15 established to the main bearing element 2. In the created structure, there is a possibility in which the used linear actuator 8 is connected to the supporting beam 12 of the supporting metal structure, and its working body is directly connected to the frame 7 of the photovoltaic modules 5. The change of the angle to the horizon of the movable photovoltaic modules 5 is the result of an interaction between the linear actuator 8, a working body is connected to the upper 9 and lower 4 arms, the frame 7, the bearing body 15, the described elements in their totality composing a tracker system.

For the exact positioning of the movable photovoltaic modules 5 and their movement relative to the change of the solstice, the tracker system thus formed can be controlled by a system including sensor devices to read the intensity of the sun, its location, environmental indicators and other parameters of relevance.

This provides the possibility of bringing the metal frames 7 with the panels 6 to a horizontal position or to another suitable angle in strong or hurricane winds. This allows securing the platform in extreme weather situations and reduces the risks of its failure and/or destruction. The movable PV modules 5 shown in FIGS. 1 and 2 are arranged on the main supporting element 2 in two opposite spaced PV fields 13a and 13b, separated from each other by service path 11. Each photovoltaic field 13a and 13b is composed of the movable photovoltaic modules 5, arranged in rows, whereby each row is composed of three to four photovoltaic modules 5 and the rows are from one to three, with shielding elements made of PVC or high-density polyethylene being established between the supporting beam 12 and the main supporting element 2, either of textiles or of fiberglass or other material of increased reflectivity.

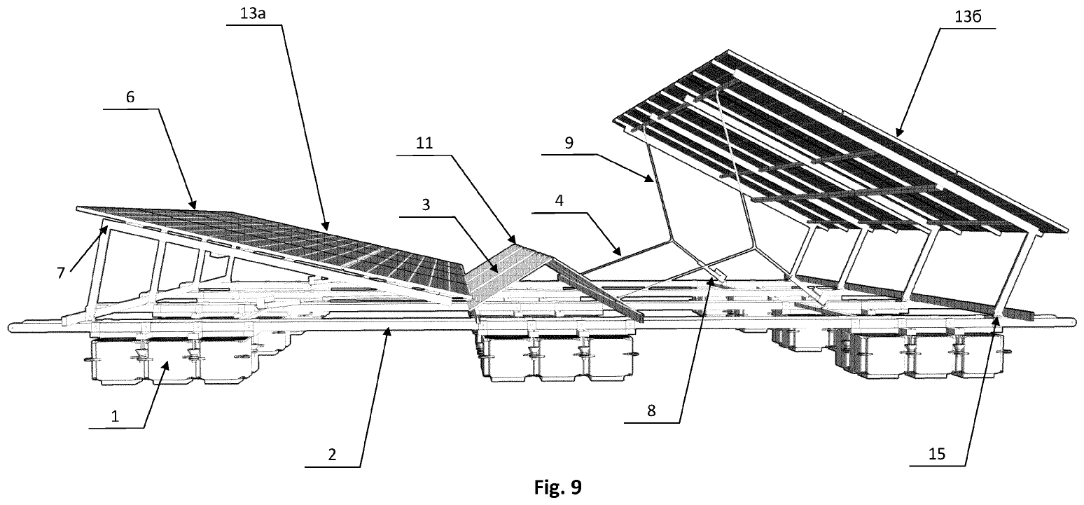

It is evident from FIG. 9 that service path 11 is composed of two elements, movably connected to each other, the angle that the two elements form is in the range from 90° to 180°.

The elements of the service path 11 are covered with a retroreflective coating 3, representing a retroreflective paint, with reflective capacity and the position of the elements relative to the horizon further increase the solar energy that falls on the lower working surface of the photovoltaic panels 6 and thus achieve higher efficiency of electricity production. When it is necessary to service the photovoltaic panels 6 or another element of the floating photovoltaic platform, the elements of the service path are brought to an angle of 180° to each other in order to more convenient and safe operation of the service personnel.

1. A floating photovoltaic (PV) platform comprising a supporting metal structure on the underside of a main supporting element, pontoon bodies formed in groups are established, each group being fixed to a metal frame of the supporting metal structure, wherein on the upper side of the main supporting element are PV modules, each of which is composed of a frame in which PV panels are housed.

2. A floating photovoltaic platform according to claim 1, wherein the supporting metal structure on the underside of a main load-bearing element pontoon bodies are established, with photovoltaic modules located on the upper side of the main load-bearing element, each of which is composed of a frame containing photovoltaic panels, where the pontoon bodies groups of pontoon bodies were formed, each group of pontoon bodies being fixed to a metal frame of the supporting metal structure, a lower arm and an actuator in which the upper arm and the lower arm at one end are connected to the working body of the actuator and the other end of the upper arm is connected to one end of the frame of the PV modules, the other end of the lower arm being connected by a supporting beam of the supporting metal structure, the opposite end of the frame being connected to a bearing body, established to the main carrier element, and shielding elements are established between the supporting beam and the main carrier element, whereby the movable photovoltaic modules are arranged on the main carrier element in two opposite photovoltaic fields separated from each other by a service path, each photovoltaic field being composed of the photovoltaic modules arranged in rows, the service path being composed of elements, removably connected to each other, and covered by a retroreflective coating.

3. A floating photovoltaic platform according to claim 2, wherein each row is composed of three to four photovoltaic modules, and wherein the rows are from one to three.

4. A floating photovoltaic platform according to claim 3, wherein the positioning or the angle of the photovoltaic modules can be adjusted.

5. A floating photovoltaic platform according to claim 4, wherein the angle of the photovoltaic modules can be adjusted relative to the horizon.

6. A floating photovoltaic platform according to claim 5, wherein the angle of the photovoltaic modules can be adjusted relative to the horizon from between approximately −15° to approximately +45°.

7. A floating photovoltaic platform according to claim 4, wherein the angle of the photovoltaic modules can be adjusted relative to the horizon from between −12.5° to +42.5°.

8. A floating photovoltaic platform according to claim 1, wherein the photovoltaic panels arranged in each PV module are located with their long side substantially parallel to the horizon.

9. A floating photovoltaic platform according to claim 1, wherein the distance between the nearest edges of the frames of the mobile photovoltaic modules is in the range of between approximately 0.1 to 3 m.

10. A floating photovoltaic platform according to claim 1, wherein the distance between the nearest edges of the frames of the mobile photovoltaic modules is in the range of between approximately 0.5 to 2.5 m.

11. A floating photovoltaic platform according to claim 1, wherein the bottom surface of the photovoltaic panels further comprises reflective elements.

12. A floating photovoltaic platform according to claim 2, wherein the actuator is a linear actuator.

13. A floating photovoltaic platform according to claim 2, wherein the reflective coating is a reflective paint.

14. A floating photovoltaic platform according to claim 2, wherein the shielding elements are made of PVC or high-density polyethylene, or textiles, or fiberglass, or other material with increased reflectivity.

15. A method of constructing a floating photovoltaic platform, the method comprising the steps of:
providing a supporting metal structure on the underside of a main supporting element pontoon bodies formed in groups are established, each group being fixed to a metal frame of the supporting metal structure, wherein on the upper side of the main supporting element are PV modules, each of which is composed of a frame in which photovoltaic panels are housed,
placing the photovoltaic platform on a floating surface; and
obtaining a floating photovoltaic platform.

16. A method of constructing a floating photovoltaic platform according to claim 15, wherein the method comprises supplying a supporting metal structure on the underside of a main load-bearing element pontoon bodies are established, with photovoltaic modules located on the upper side of the main load-bearing element, each of which is composed of a frame containing photovoltaic panels, where the pontoon bodies groups of pontoon bodies were formed, each group of pontoon bodies being fixed to a metal frame of the supporting metal structure, whereby the photovoltaic modules were movable with the possibility of changing their angle relative to the horizon from −15° to +45° by a lever module composed of an upper arm, a lower arm and an actuator in which the upper arm and the lower arm at one end are connected to the working body of the actuator and the other end of the upper arm is connected to one end of the frame of the PV modules, the other end of the lower arm being connected by a supporting beam of the supporting metal structure, the opposite end of the frame being connected to a bearing body, established to the main carrier element, and shielding elements are established between the supporting beam and the main carrier element, whereby the movable photovoltaic modules are arranged on the main carrier element in two opposite photovoltaic fields separated from each other by a service path, each photovoltaic field being composed of the photovoltaic modules arranged in rows, each row being composed of three to four photovoltaic modules, and the rows are from one to three, the service path being composed of elements, removably connected to each other and covered by a retroreflective coating.

17. A method according to anyone of claim 16, wherein each row is composed of three to four photovoltaic modules, and wherein the rows are from one to three.
